(19) United States
(12) Patent Application Publication
(10) Pub. No.: US 2014/0164255 A1
(43) Pub. Date: Jun. 12, 2014

(54) SYSTEM AND METHOD FOR DYNAMIC TRANSACTION MANAGEMENT AND COLLABORATIVE AUTHORING OF A NEGOTIABLE DOCUMENT

(71) Applicants: John E. Daly, Coral Gables, FL (US); Emil Stefanutti, Miami, FL (US); Margaret T. Daly, Coral Gables, FL (US); Peter L. Thomson, Coral Gabes, FL (US)

(72) Inventors: John E. Daly, Coral Gables, FL (US); Emil Stefanutti, Miami, FL (US); Margaret T. Daly, Coral Gables, FL (US); Peter L. Thomson, Coral Gabes, FL (US)

(73) Assignee: CONTRACT ROOM, INC., Coral Gables, FL (US)

(21) Appl. No.: 13/893,167

(22) Filed: May 13, 2013

Related U.S. Application Data
(60) Provisional application No. 61/646,239, filed on May 11, 2012.
(60) Provisional application No. 61/723,362, filed on Nov. 7, 2012.

(51) Int. Cl. G06Q 50/18; G06Q 10/06

(52) U.S. Cl. CPC G06Q 50/188; G06Q 10/0631
USPC 705/80

(57) ABSTRACT

A system and method for enabling coordinated, collaborative, data-driven document negotiation among multiple, divergent parties, either internally or externally, in a virtual environment. A comprehensive, singular, transaction management platform that transforms documents from a manual, text-based and paper-laden business and legal process into a data-driven experience via a negotiable transaction environment. The system streamlines and automates coordination of the life cycle of a binding document from deal origination to collaborative negotiation to executed agreement to archival to system-generated analytics. A term-based engine replaces the manual business and legal processes, and streamlines management of communication, approvals, signatures, commenting, recordkeeping and documentation. It provides a collaborative process for authoring text-based terms, as an alternative to an iterative, sequential drafting process; and an online, real-time searchable history of all changes for later discovery and/or compliance. As the system gathers data from transaction activity and final agreement, it dynamically builds workflow deliverables as well as analyzes resultant data and creates actionable business intelligence.

### CROSS-REFERENCE TO RELATED APPLICATIONS

This application claims the benefit under 35 U.S.C. §119(e) of U.S. Provisional Application 61/646,239, filed May 11, 2012, and entitled System and Method for Dynamic Transaction Management, and U.S. Provisional Application 61/723,362, filed Nov. 7, 2012, and entitled System and Method for Collaborative Authoring, each of which is hereby incorporated herein by reference.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

1. Field of the Invention

The invention relates generally to the field of transaction negotiation and management systems and collaborative authoring of a negotiated document and seeks to transform the business and legal process of transaction between one or many parties. More specifically, the invention transforms documents from a manual, text-based and paper-laden process into a data-driven experience via a dynamic, negotiable transaction environment. More specifically still, the invention relates to a system and method for enabling coordinated, collaborative, data-driven contract (and/or other document types) negotiation among multiple, divergent parties either internally or externally in a virtual environment. More specifically still, the invention (certain embodiments of which may be commercially referred to as the CONTRACTROOM® system or platform (“herein CONTRACTROOM®”) and/or the Pro-Authoring™ feature or module of a transaction management system or similar platform) seeks to enable the streamlining of a complete contract/document workflow via a single platform that enables users to: organize and participate in online negotiations; formulate, modify and electronically execute contracts; systematically invite receiving parties (also referred to as a “counterparty” or “counterparties”) into active negotiation sessions; dynamically create, assign and control negotiation team permissions and alerts; structure and coordinate activities for negotiation team members and capture all actions (history, versions, comments) within the system as they relate to each finite negotiation session or instance; transfer and share information/data among multiple users in multiple locations in multiple time zones and in multiple languages; manipulate, prepare and present real-time data from each negotiation session or instance for purposes of fulfillment, analytics, alerts, reporting, audits, compliance, among other deliverables; and/or streamline and automate the process of a text-based negotiation, among other features.

2. Description of the Related Art

Businesses have increasingly turned to computer services and the Internet to better manage documents, in general, and more specifically the contract life cycle, from origination through negotiation, agreement, monitoring, execution, post-execution, and archival. To accomplish this goal, businesses frequently use several different technologies in attempt to consolidate and automate the negotiation and/or contracting process. Some of these technologies include: E-mail, PDF tools, Contract-Related Software, and Electronic Signatures. However, long-time professionals have found that in most industries and verticals, such as technology, media, financials and real estate, which are very contract-intensive, the process is still overwhelmingly dependent on manual and fragmented workflows.

In business today, contract origination and initial offers usually begin with phone calls, emails, and faxes between negotiation parties. An original offer is created and sent by faxing paper contracts or emailing PDF files to the counterparty. In order to make a counter offer, the counterparty typically uses a printout of the contract manually inputting or handwriting strikeouts, edits, comments, and initials onto the original document. This is done in order to keep track of the negotiation history. Once the counteroffer is prepared, it is faxed, scanned, or emailed back to the other party. The receiving party will use the same process to prepare and send back a counteroffer. This back-and-forth workflow occurs until an agreement is reached. Once the agreement is finalized, users can execute the contract by hand-written signatures or electronic signature technologies. E-Signature technologies, such as Docusign® or Adobe®'s Echosign®, require the document to be uploaded via an E-Signature website or API and sent by email to the signatories.

The only real digital part of today's status quo negotiation process is the transfer of the file by uploading or scanning it onto a computer and sending it via email. Furthermore, the nature of the back-and-forth flow of a fixed original document limits a business's ability to establish fluid internal and business-to-business communications, accelerate the time it takes from deal origination to contract execution, promote accountability and transparent monitoring, extract metadata analytics, and consolidate other business operations into one platform.

In many contract negotiations, even after the parties have reached an agreement in principle, a remaining step is to arrive at a final document embodying that agreement. In the context of an electronic system, this process may often be handled through an iterative drafting process known as “red-lining”, which can be laborious, contentious and counterproductive. In word processing, redlining refers to marking text that has been edited. Typically, redlining is used when two or more people are working on a document together; each individual can redline the text he or she has added or edited. The redlined text will then appear in a special color (or as bold, annotated, etc.) so that others can see the changes that have been made. Redlining a document, also known as Track Changes in Microsoft® Word, is a computer process by which changes are identified between two versions of the same document for the purposes of document editing and review.

The software-based document comparison process compares a reference document to a target document, and produces a third document which indicates (by colored highlighting or by differing font characteristics) information (text, graphics, formulas, etc.) that has either been added to or removed from the reference document to produce the target document. Common document formats for comparison include word processing documents (e.g. Microsoft® Word), spreadsheets, presentations (e.g. PowerPoint), and Portable Document Format (PDF) documents.

In some systems, during a document negotiation, all the words in the document (proposal, agreement, contract or otherwise) are scrutinized and available for modification by either party. The process may begin with the document/contract owner creating an offer with the term details spelled out in a document, which may be created using a word processing program and sent to the counterparty for consideration. Oftentimes, the counterparty unilaterally makes modifications to the document using redlining or comparable functionality. This type of exchange may be repeated a number of times, with the document being sent back and forth with changes being rejected or accepted until a final document is co-created by both parties.

Methods of this nature, however, may have one or more of the following characteristics: (1) they lack a formal system or process to capture data and manage the changes, neither with the counterparty or within one's own negotiation team; (2) users lose track of the changes unsure of the accuracy of the most recent version which requires; (3) users must proofread the most recent version of the document against previous iterations to ensure changes were not modified or deleted; (4) after several iterations, it may simply be too difficult and time-consuming to navigate through a document with hundreds of potential changes/revisions. Depending upon a particular application, it may be desirable to partially or fully remove or improve upon one or more of these factors and others.

### SUMMARY OF THE INVENTION

The system and method of the invention seek to provide a comprehensive platform that enables the features necessary or desired to coordinate the life cycle of a binding agreement from deal origination to contract execution to transaction management to business intelligence. Such features may include, among others, accelerating (i.e. shortening the time required) individual steps and/or the overall process; facilitating internal and business-to-business communications; promoting accountability and transparent monitoring; extracting metadata analytics; and consolidating other business operations. In certain embodiments, a system and method of the invention further seeks to facilitate and manage the generation of a negotiable document, as in the context of a platform for coordinating the life cycle of a binding agreement from deal origination to document execution to transaction management to business intelligence.

The system may be built in a way that enables metadata creation, control, distribution and intelligence by digitizing each piece of an original negotiable document (i.e. terms, conditions, etc.) and building dynamic online negotiation environments. The front-end negotiation interface of the environment is shared by users of every party and manipulated based on a set of basic permissions. Meanwhile, the front-end interface is tied on the back-end to the original negotiable document boilerplate, so that as the users move through the negotiable document lifecycle the process can be completely automated. This means that whatever action a user performs in the front-end interface (i.e. change a negotiation term, make a counteroffer, electronically sign the finalized agreement, etc.), it is being processed, stored, and tracked on the back-end while generating a dynamic front-end that is shared and synced with the applicable users.

In one embodiment, the invention is offered in the form termed Software as a Service (SaaS), as discussed in greater detail herein. In this embodiment, the system may be completely web-based and not require both parties to subscribe to the service or have any other software licenses. Therefore, the service can extend to any person or business with Internet access.

In one aspect, the invention includes a system and method for digitizing negotiable document terms for interactive negotiation, which may include a process of deconstruction, i.e., separating negotiable document text from terms (negotiable items). Preparation of the negotiable document for negotiation may further include digital attributes being assigned to each term (date, currency, etc.) and tagged. The tag is then dragged into the negotiable document text identifying where it appears in the negotiable document once published. Signature fields are also identified and located in the contract. The negotiable document is made available for negotiation in a structured negotiable environment, referred to as a Contract Room™ environment. A Contract Room environment (with a space in between Contract and Room) is broadly defined as the environment where the transaction dealings occur (i.e. origination, negotiation, finalization, execution, etc.). A user will use a different Contract Room environment for every transaction or deal negotiation. A Contract Room environment is set up prior to deal origination and has an extremely flexible interface, so that a Contract Room environment can mirror the widest possible scope of business processes and deals in a company's Contract Management Lifecycle, such as: varying terms, party lines, approvals, etc. The output of a Contract Room environment is a specialized digital contract. These Contract Room environments and digitized contracts are managed within what is termed the CONTRACTROOM® platform, which platform may be implemented in a variety of ways, as described herein.

In another aspect, the invention provides a data-driven environment for structured negotiable document negotiation through a dynamic process, including a system and method for user-defined negotiation between team members and counterparties. The system creates a team leader, the individual creating a negotiable document offer, the beginning of a negotiation. Each team leader can negotiate directly with the counterparty or create his/her own team. Other term participants are invited into the negotiation. Each member has the ability to negotiate, view or approve the contract, plus the ability to sign. The team leader assigns one or many of these roles and responsibility to each participant. These roles are based on the individual's function in the negotiation. Agreements between teams are based on the team settings, all agree, some agree or one decides on a term for the term to be approved or countered.

In another aspect, the system collects user data throughout the negotiation and contracting process. Subscribers define how that data is disseminated throughout the organization pre- and post-contract. Definitions include directing specific information to individuals and departments inside and outside the organization. Data can be sent via email, or text or via integration with other existing technologies. Data can also be configured as timers and alerts to notify users of deadlines or other delivery requirements. Configurations can be defined by agreement template or by individual negotiation.

In another aspect, the system collects user data throughout the negotiation and contracting process for the provisioning of enterprise metrics. Subscribers define how the system analyzes that data and presents it to the user. Personal dashboard: Each CONTRACTROOM® subscriber has a personal dashboard reflecting that user's active and completed negotiations. Personal dashboards are configurable to compare the individual's performance to other subscribers in the enterprise. The system allows managers to see aggregate and individual performance of the users they oversee. Default analytics include: the risk a negotiation will or will not be concluded, projected income or expenses, existing and projected inventory demand, the number of times an agreement template has been used, and template clause and content performance. The system also manages timers and alerts associated with negotiable document deliverables.

In another aspect, the invention enables the extraction of negotiable document intelligence through a system and method for mining and reporting on document negotiation data. For example, the system may enable mining of meta-tag/term data and, in turn, deliver business intelligence on financial projections, sales and revenue pipeline, closing potential by contract, individual salesperson performance, and individual salesperson negotiation strengths and weaknesses, etc.

In another aspect, the invention provides negotiable document alerts through a system and method for delivering alerts and communications during and after document negotiation. The user assigns a unique set of actionable instructions to each negotiable item in a contract. When the data triggers the instructions, custom designed alerts and communications are sent to recipients during and after document negotiation.

In another aspect, a system and method of the invention enable a determination of negotiable document risk, i.e., an identification of the risk of losing a negotiation, such as by monitoring active document negotiation metadata (terms) and processing that data through an algorithm that identifies the potential risk of losing the deal. As more document negotiations take place, the system builds custom modeling unique to the organization using the system.

In another aspect, the invention enables multilingual negotiations through a system and method for translating the Categories and Items, so that parties can look at the dynamic, virtual negotiation environment in their native language, allowing users to select the language in which they wish to negotiate.

In another aspect, a Pro-Authoring feature or module in the context of document negotiation creates a formal structure and process for making collaborative text changes between two or more parties. First, the text (sometimes referred to as “legalese”) from a legal document (proposal, contract, agreement, or otherwise) is prepared by the drafter of the originating party (or “Contract Originator”) involved in a negotiation and uploaded into a contract or document management system.

In another aspect, after all business terms have been negotiated and agreed upon, the party that did not create the negotiable document (known as the “Counterparty” or an internal team member of the “Contract Originator”) is presented the legal text/terms for review and acceptance. If the reviewer does not agree with the text presented, then such individual(s) must formally request changes to the originating party, therein providing a formal, recorded comment that could include the context (the rationale for the requested change) and/or the content (the suggested text change) to be incorporated into the original draft.

In another aspect, the originating party must accept or reject the request and, if rejecting, may provide his/her explanation/comment for the rejection of such “change request”.

In another aspect, once a change request is accepted, the originating party (and/or his/her designated Author/Editor) may be designated as the only user with redrafting privileges. Once the text is redrafted with all the agreed upon text changes, the negotiator and/or reviewer has the ability to accept or reject the rewrite.

In one embodiment, Pro-Authoring's digital process: (1) ensures that all text changes are clearly documented in an audit history that is easy to source and follow; (2) creates a framework and process for text-based negotiation; (3) facilitates flawless consensus between a negotiation team and the counterparty; and/or (4) shows the most recent approved text version. If a text change request has not been approved with newly authored text, users do not see the change.

To summarize, a comprehensive, singular transaction management platform that enables coordination of the life cycle of a binding agreement from deal origination to negotiable document execution to transaction management to business intelligence in an effort to transform the business and legal process of one or many parties reaching consensus on transactions. The system and method controls the process of transforming documents from a text- and paper-based environment into a data-driven negotiable transaction environment. Each negotiable transaction environment is fueled by a negotiation engine that replaces the manual processes of face-to-face, phone, email, and offline discussions as well as the manual and time-consuming administration involved with receiving approvals, signoffs, signatures, commenting, recordkeeping and documentation. The system and method streamlines and automates the negotiation process amongst two or more parties of making collaborative changes to text-based terms as a partial or complete alternative to the iterative drafting process known as “red-lining,” which can be laborious, contentious and counterproductive. The invention encourages a timely, efficient and productive term/text resolution, by promoting agreement on context (rationale) before content. It also provides an online, real-time searchable history of all changes, versioning, commentary, drafting and authoring related to the stored/hosted data and text terms captured in each specific, unique negotiation session or instance, which may be required by any of the negotiation participants or other authorized stakeholders for purposes of discovery, compliance or audit.

Additional features and advantages of the invention will be made apparent from the following detailed description that proceeds with reference to the accompanying Figures.

A portion of the disclosure of this patent document, in particular the figures, contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BRIEF DESCRIPTION OF THE DRAWINGS

FIG. 1 is a schematic overview illustrating architecture, functionality, and workflow of a web-based platform for dynamic, data-based negotiable transaction management and a flow chart illustrating a set operations for users to follow through the business and legal process of reaching consensus or agreement on transactions, according to an embodiment of the invention.

FIG. 2 is a schematic overview of an application of a web-based platform that controls user account activation on a web-based platform, according to an embodiment of the invention.

FIG. 3 illustrates features of a graphical user interface that controls user account preferences and management that may be provided via a web browser an as application dashboard, according to an aspect of the invention.

FIG. 4 is a flow chart of an application to create data-centered specialized digital documents enabling dynamic transaction management and online negotiations, according to an embodiment of the invention.

FIG. 5 is a flow chart illustrating an example of a set of operations to create data-centered specialized digital documents, according to an embodiment of the invention.

FIGS. 6-7 illustrate features of a graphical user interface that may be provided via a web browser as an application dashboard, according to an aspect of the invention.

FIGS. 8A and 8B are schematic overviews of an application for a web-based platform that controls creation of a dynamic negotiable transaction environment for active exchange, control and intelligence building of transaction data and a flow chart illustrating a set of operations for users to perform online negotiations and transaction management, according to an embodiment of the invention.

FIG. 10 illustrates features of a graphical user interface that may be provided to users for previewing a reconstructed document while involved in an active online negotiation and transaction management session, according to an aspect of the invention.

FIG. 11 illustrates features of a graphical user interface that may be provided to users for tracking history of online negotiations and transaction management, according to an aspect of the invention.

FIG. 12 is a schematic overview and data flow diagram of a method in accordance with a collaborative authoring system and method of a negotiable document, according to an embodiment of the invention.

FIG. 13 illustrates features of a graphical user interface that may be provided in accordance with a collaborative authoring system and method of a negotiable document, according to an embodiment of the invention from a perspective of a Counterparty.

FIG. 14 illustrates features of a graphical user interface that may be provided to users for online negotiation finalization and negotiable document execution via electronic signatures, according to an aspect of the invention.

FIG. 15 illustrates features of a graphical user interface that may be provided to users for business intelligence purposes and data analytics, according to an aspect of the invention.

FIG. 16 illustrates features of a graphical user interface that may be provided to users for dynamically controlling the flow of data from online negotiations into active operation, according to an aspect of the invention.

FIG. 17 illustrates a schematic overview of infrastructure technology that may be used to provide the service to users through web devices, according to an embodiment of the invention.

### DETAILED DESCRIPTION OF THE INVENTION

In the following detailed description of the invention, reference is made to the accompanying Figures, which illustrate specific exemplary embodiments of the invention. It should be understood that varied or additional embodiments having different structures or methods of operation might be used without departing from the scope and spirit of the disclosure.

As discussed herein, a system and method of the invention seek to provide a comprehensive platform for transaction management by transforming text-based, paper-laden document processes into dynamic, negotiable data environments in an effort to transform the business and legal process of one or many parties reaching consensus or agreement on transactions. In one embodiment, transactions of interest include those occurring during the life cycle of a binding agreement from deal origination to negotiable document execution, enabled by way of a negotiable document management system and associated methods. Some or all of these transactions might occur “online” in the sense of communication between parties at different locations, which may range from different terminals in the same room to different rooms to different cities or countries or other locations, etc. This communication might include use of the Internet or World Wide Web, or other suitable wired or wireless communication means for enabling the transactions and interactions disclosed herein.

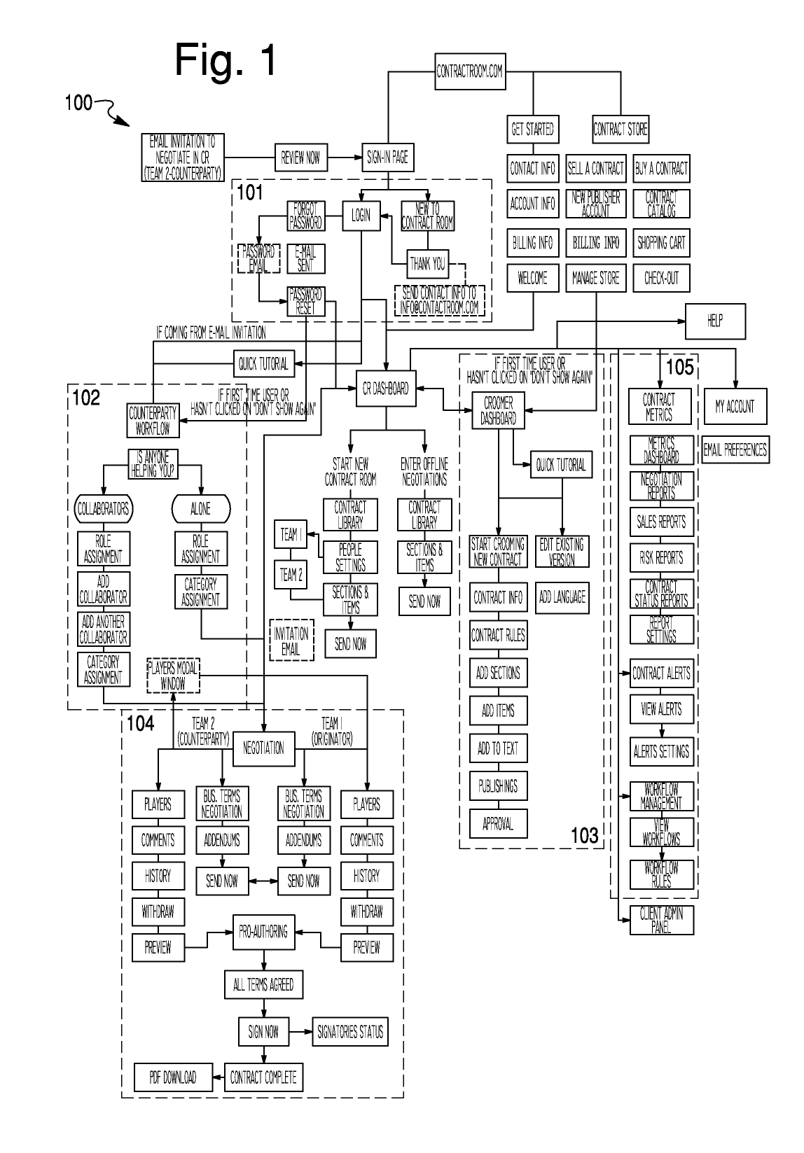

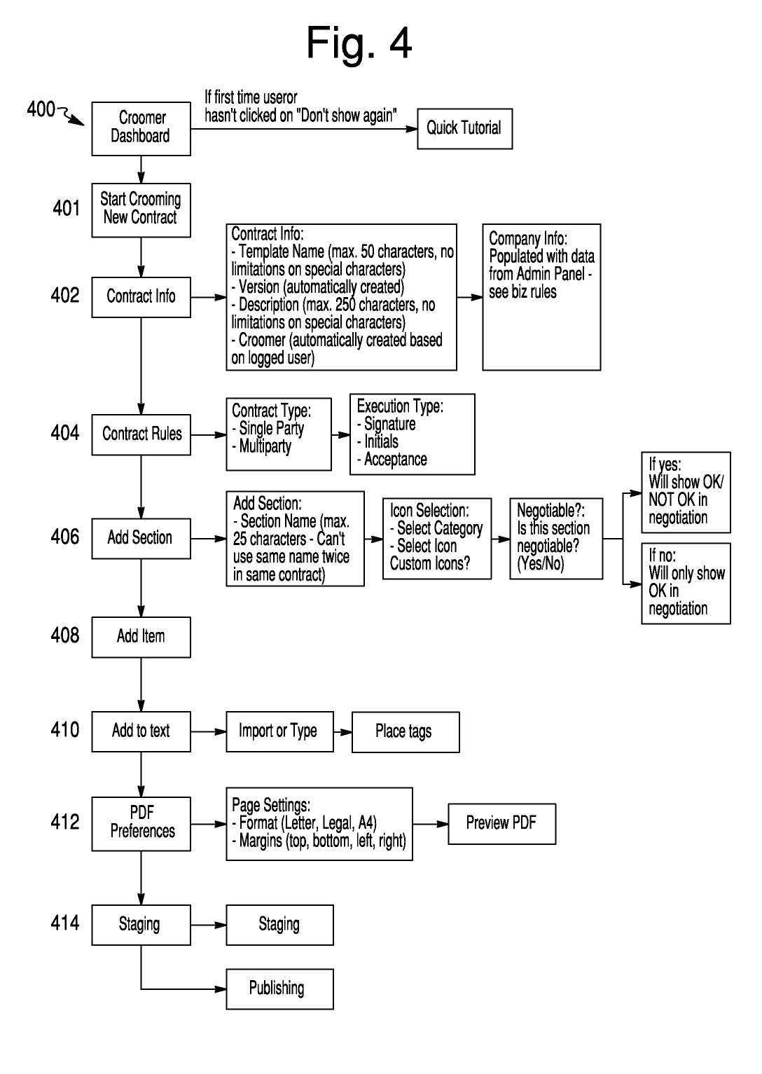

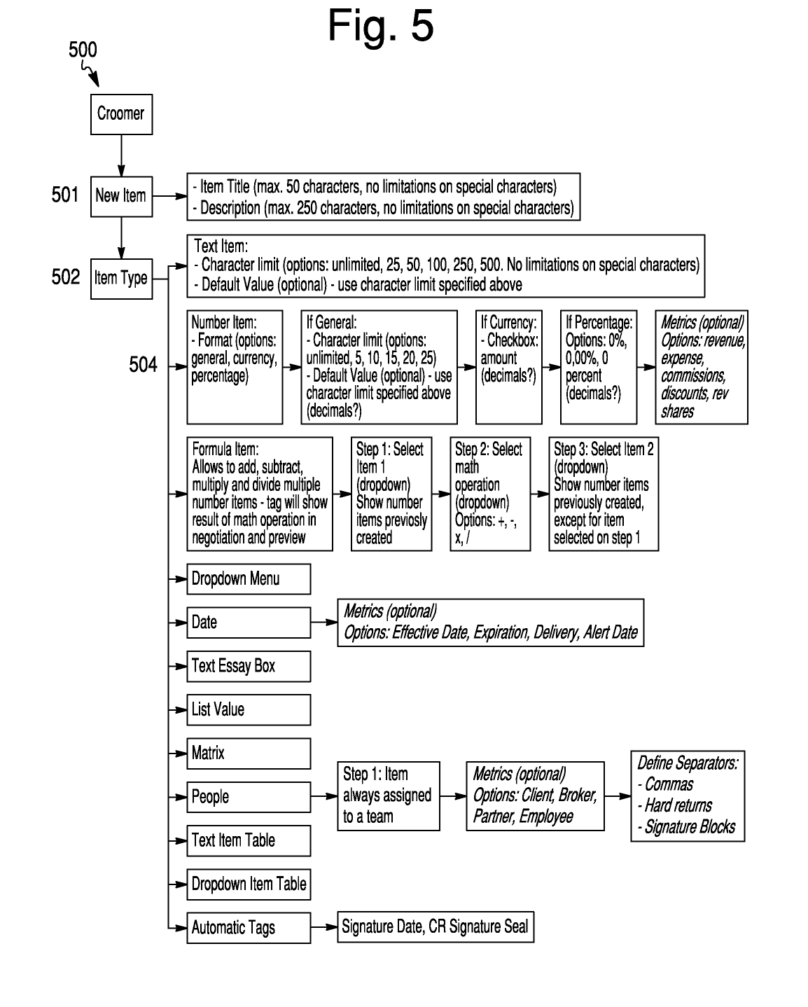

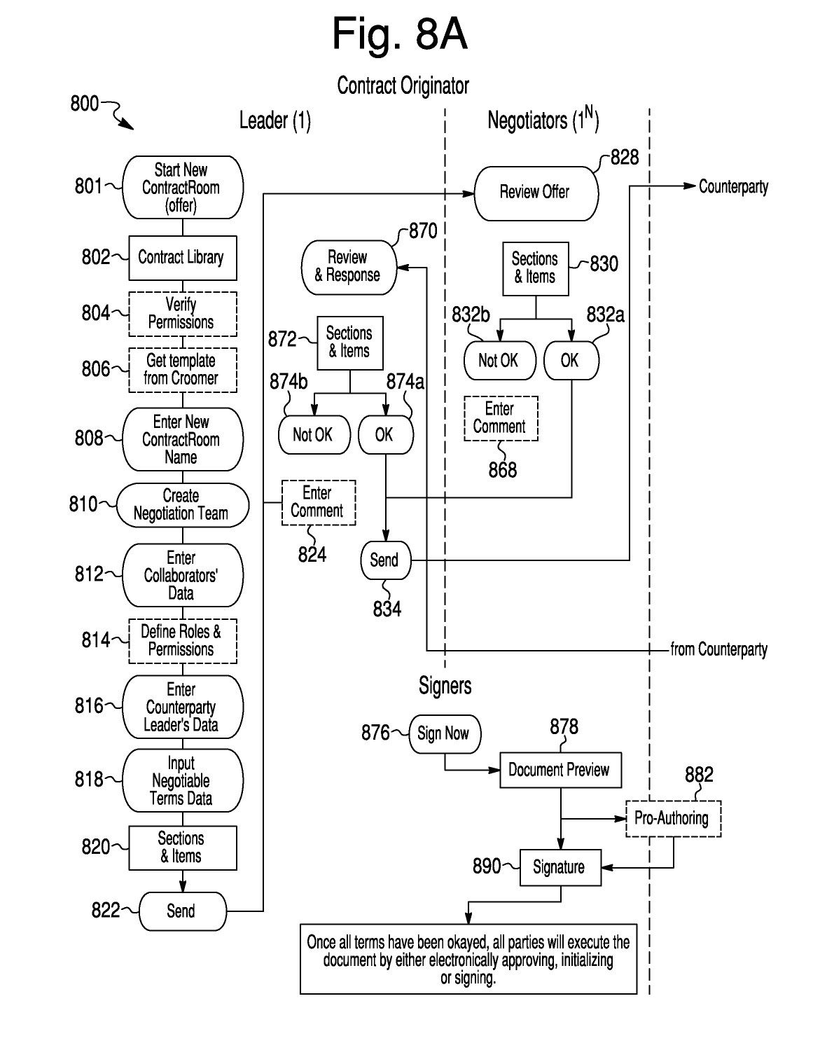

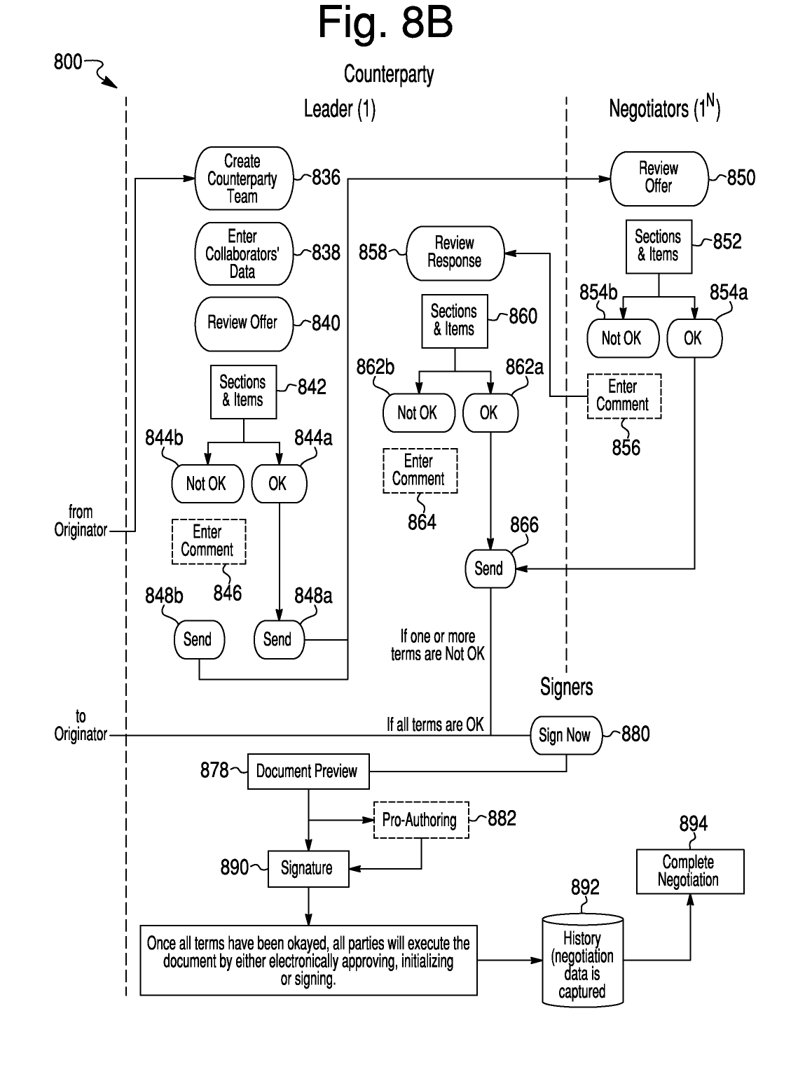

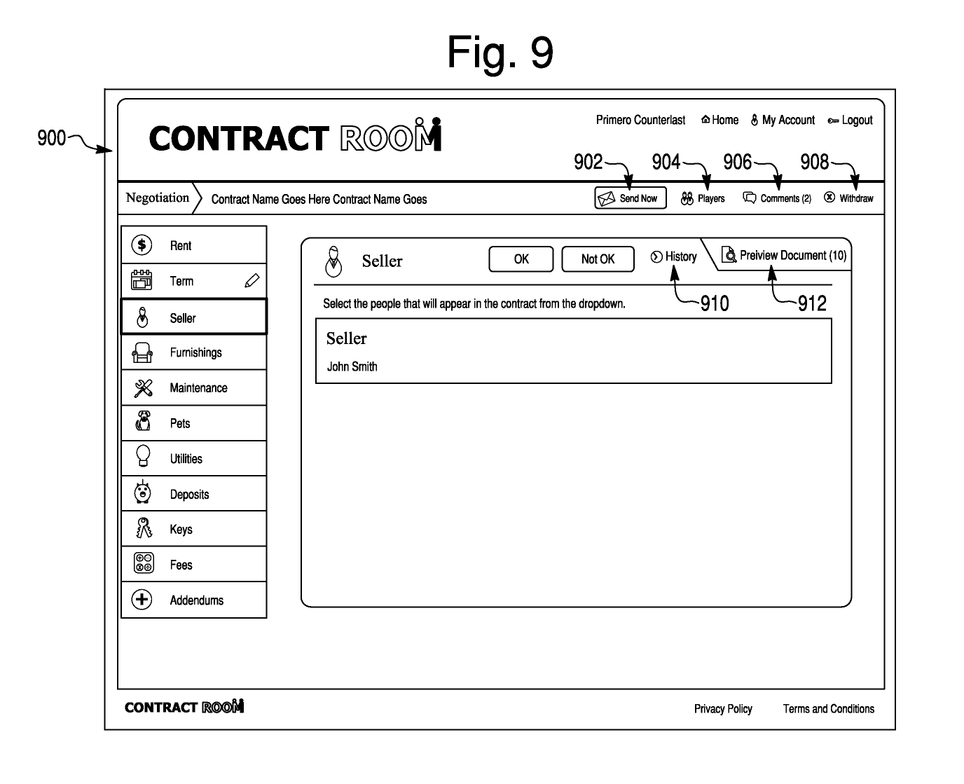

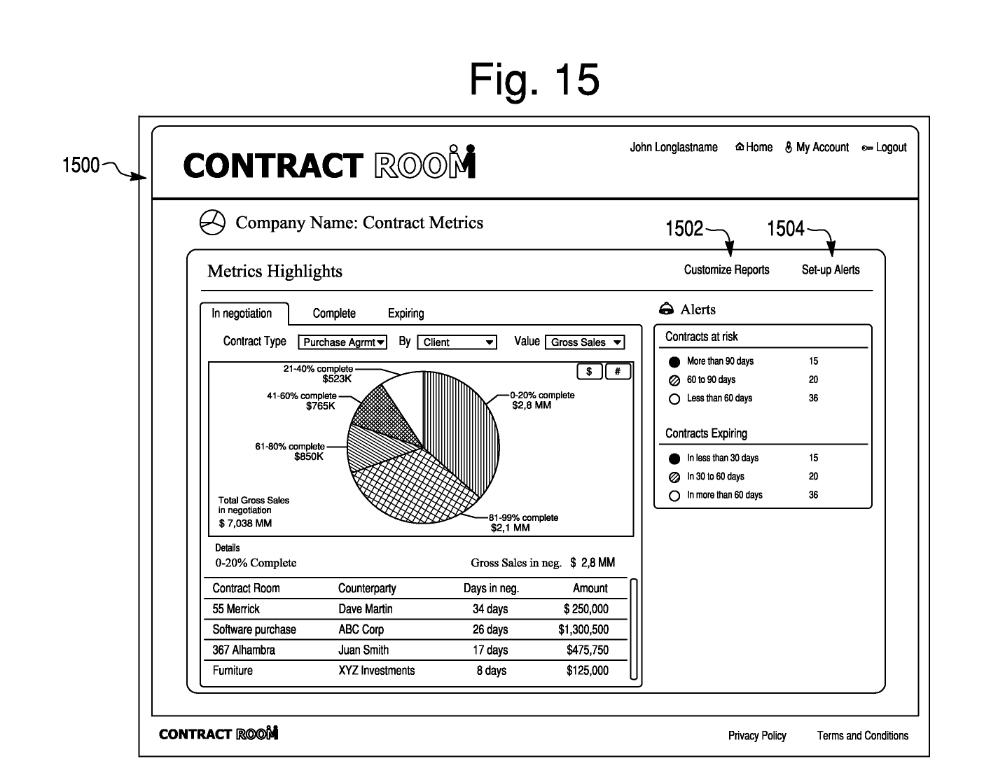

The invention might be applicable to a variety of fields and industries, including Media, Technology, Finance, Consulting, Telecommunications and Real Estate, among many others. A macro-depiction of an embodiment of a system in accordance with the invention is presented in FIG. 1. This embodiment is implemented and described in the context of Software as a Service (“SaaS”), with FIG. 1 illustrating a product map or overall blueprint of the software as exemplary sections 101-105, functionality, and workflows (i.e., flow charts or logic diagrams), as for example might be implemented through a website or other web-based space, although the features of the invention might be offered in a variety of other ways. Section 101 illustrates the mechanism by which users will access the platform and system. Section 102 illustrates the process of engaging another party (“Counterparty”), as is further explained in FIG. 8 into a negotiable virtual environment and instance. Section 103 illustrates the process of deconstructing a negotiable document for preparation into the virtual platform's negotiation environment, via a tool referred to as the “Croomer®”, as is further described herein in FIGS. 4 and 5. Section 104 illustrates the dynamic, collaborative process on negotiation of variable data and fixed text terms, which results in a legally agreed-upon, executable document (as further illustrated in FIGS. 8A and 8B). Section 105 identifies the components that create dynamic and proactive actions based on agreed-upon data and text terms for each negotiation instance within the negotiation engine, referred to herein as “Contract Metrics”, “Contract Alerts” and “Workflow Management” (as further illustrated in FIG. 15). This virtual platform in its many forms, as described or otherwise included within the scope of this disclosure, is referred to herein as the CONTRACTROOM® platform (herein “CONTRACTROOM®”).

CONTRACTROOM® can be used in any industry/sector where there are buyers and sellers of assets or products or services, or there otherwise are 2 or more individuals negotiating, either internally for consensus or externally for formal agreement. In one embodiment, CONTRACTROOM® not only manages the negotiation and workflows for specific individuals, but can also call in additional users for a variety of purposes to help negotiate, authorize, manage, maintain, and renew a specific or range of contracts/agreements. In this way, CONTRACTROOM® takes the pain out of the entire contracting lifecycle and may allow for a simpler negotiation, smarter negotiable document and better business.

The system/solution was developed with the flexibility to apply to any industry, sector, and circumstance. For purposes of illustration, disclosure will be provided through and in the context of a specific example to illustrate CONTRACTROOM®'s overall workflow and core functionality, while demonstrating the power and potential of this wide-ranging solution.

Consider for purposes of illustration a Sales Manager who manages a team of Sales Associates at a realty company. The Manager wants to implement the use of CONTRACTROOM® for all of his team's operations concerning Residential Leases (similarly, it could be a sales representative executing a software license agreement for a computer software provider or, for that matter, an individual or entity that desires to negotiate and reach consensus/agreement on any document). Once the situation arises in which a negotiable document must be negotiated, a method for taking contracts and negotiations online is provided in accordance with the invention. In one embodiment, by following a four-step process, users are able to configure dynamic negotiation environments based on the negotiable items of any contract or agreement. Below is the core workflow of an embodiment of the process:
1. Deconstructing the text of an original contract/document canvas;
2. Uploading document text into the system and storing it as a text field, and subsequently creating data fields for the negotiation environment;
3. Restructuring the original contract's building blocks (its terms or rather “negotiable items”) in a specialized digital format to construct an online negotiation interface;
4. And, ultimately, linking the document (proposals, contracts, agreements, etc.) in the negotiation interface back to the original negotiable document template (“boilerplate text”) for finalization.

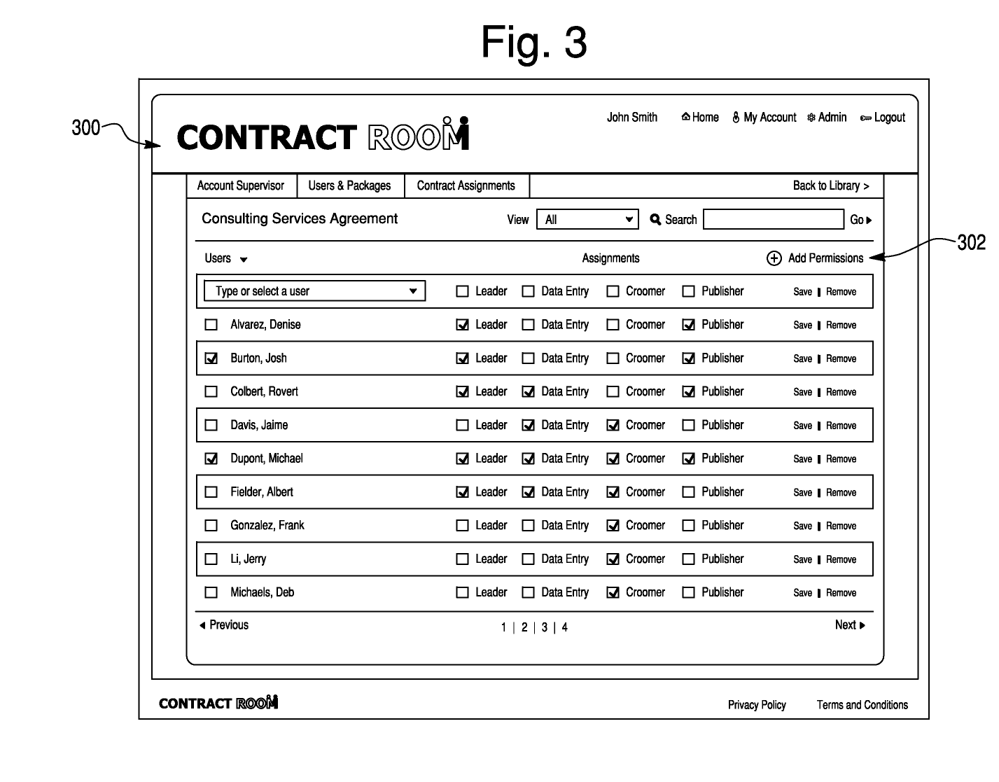

This process may be implemented as a tool, feature or service in accordance with the invention termed the CROOMER® service or tool (herein “CROOMER® tool”), which gives rise as well to relative terms such as: “to Croom”, “Crooming”, and a “Croomed Contract”, etc., indicating that a negotiable document has been processed using the CROOMER® tool. Depending upon a particular implementation of the invention, it may be desirable to control use of the CROOMER® tool through system permissions as reflected in step/process 302 in FIG. 3, discussed further herein. In one embodiment, the CROOMER® tool is only to be used by CONTRACTROOM® employees who will use it to process a user's original negotiable document into CONTRACTROOM®. Alternatively, in one embodiment, the CROOMER® tool will be made available for use directly by users or by a 3^{rd} party such as a vendor, so that they may process and customize their own original contracts into CONTRACTROOM® without the help of CONTRACTROOM® staff.

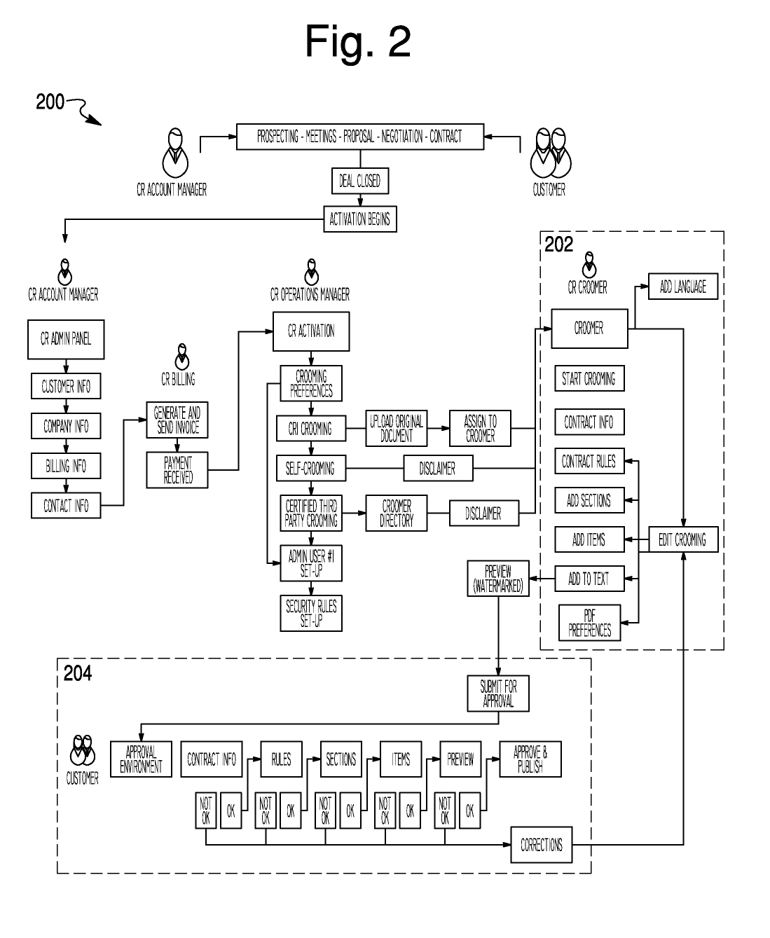

Continuing with the above example, the Manager has only activated his/her CONTRACTROOM® Account, as shown as a flow diagram in FIG. 2. The activation process shown as a method 200 is provided by way of illustration only, as variations are contemplated. Section 202 illustrates the next step for the newly activated account owner for which they will upload negotiable documents for transformation into negotiable template/canvas within CONTRACTROOM®. Section 204 illustrates the approval process for those individuals that will be involved in future negotiations using such transformed (deconstructed) negotiable documents.

In order to have the Residential Lease contract made available for use in CONTRACTROOM®, the Manager has chosen to email a Microsoft® Word® or other format copy of the original contract to the staff at CONTRACTROOM® to be processed in the CROOMER® tool. For illustration, the term “Publisher” is employed to denote a CONTRACTROOM® employee in this example, or another party that digitizes the contract, who is using the CROOMER® tool to process a client's original contract.

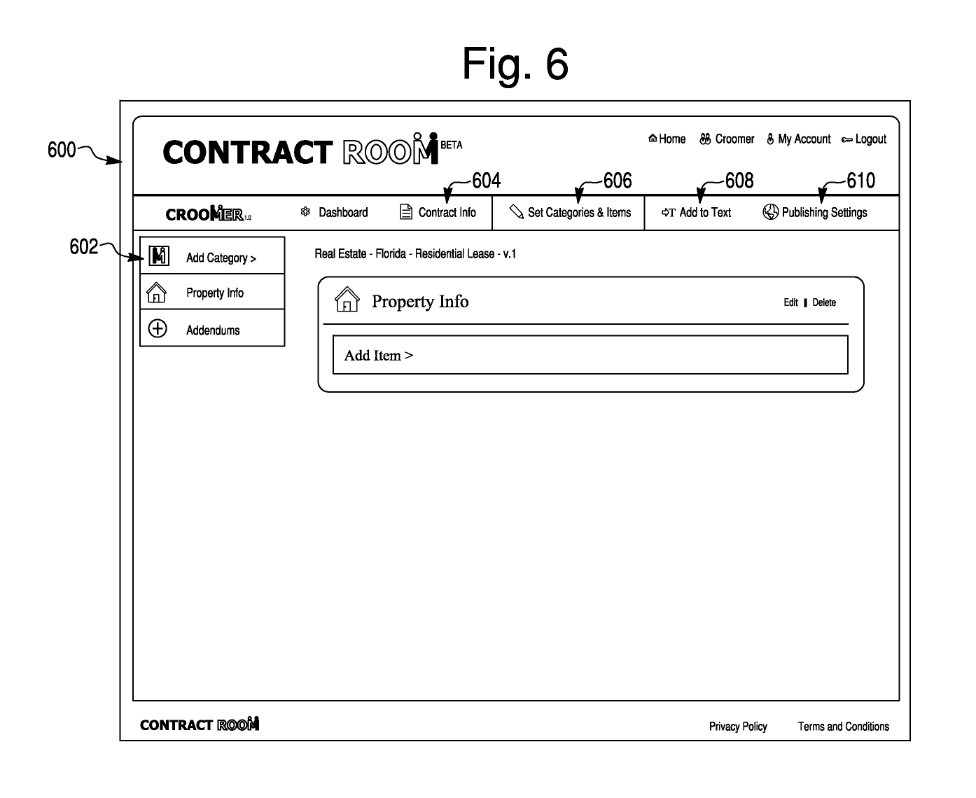

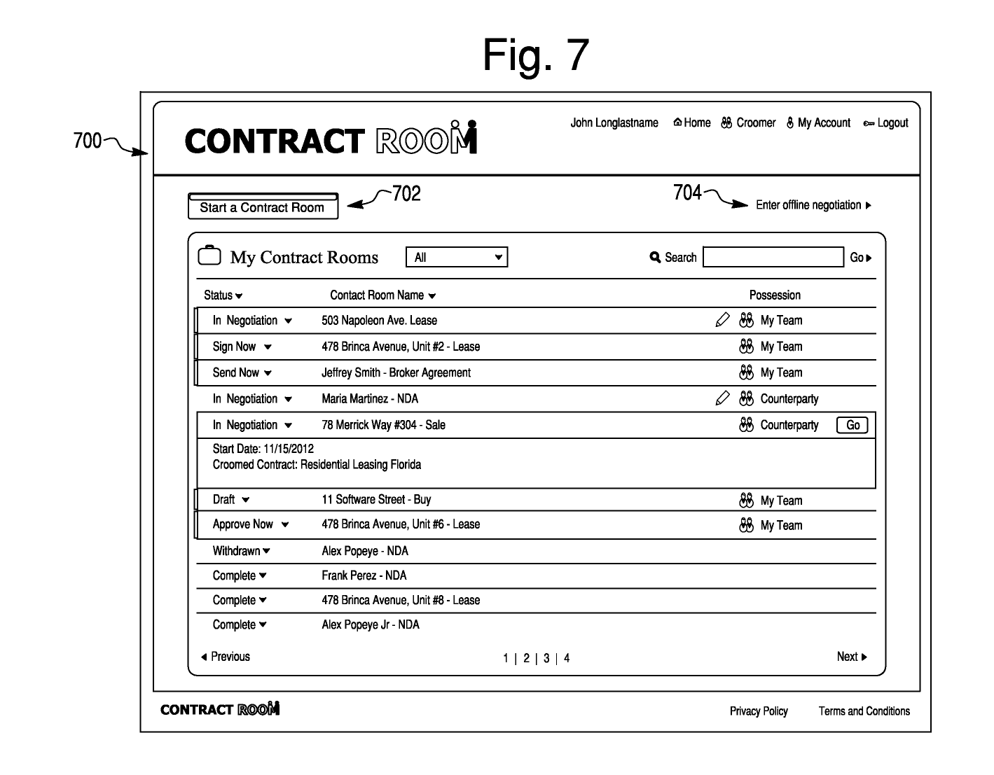

In one embodiment, as shown as a data flow diagram in FIG. 4 and steps/methods 201-214 in accordance with the invention proceed as described herein. The CROOMER® Start Crooming New Contract step 201 is provided by way of illustration only, as countless variations are contemplated. References in the text are to steps or logical decision points in accordance with FIG. 4, as well as to screenshots provided in additional FIGS. 6-7.

In the illustrative embodiment, when beginning in the CROOMER® tool, the Publisher will be directed to the CROOMER® Dashboard 200 which from a user interface standpoint, acts as a functional starting point to Croom a new contract, as illustrated in FIG. 4. The dashboard, embodiments of which are variously illustrated in FIGS. 6 and 7 is mainly comprised of:
1. A header that displays the user's name and provides links to quickly jump to the Home Page, My Account, Administration, or Logout.
2. A link to Croom a new contract
3. A library containing the user's previously Croomed Contracts

In this illustrative embodiment in FIG. 4, the Sales Manager is a first-time customer. Therefore, the Publisher will choose to “Croom New Contract” on the CROOMER®Dashboard. By doing so, the Publisher will be directed to the first step labeled as “Contract Info” 402. The Publisher will enter the negotiable document and company information at this point, and as it relates to the example, the publisher could name the negotiable document “Residential Lease” and would then input the realty company as the owner listing the Manager as the Contact Person. After filling out the appropriate fields, the Publisher will select “Save & Continue” and move to the second step in the Crooming process. What follows is assigning the appropriate Contract Rules 404, such as how many parties will be involved in negotiation and how the document will be formally executed. Then, the publisher is stepped through a process of adding sections 406 to the online template/canvas.

In one embodiment, the order of operations set forth in this step is as follows: The next step in the Crooming process is to create negotiable item via, in one embodiment, a method 500, which corresponds to step 408 in FIG. 4 and is further illustrated in steps 501-524 in FIG. 5. The detailed process of adding negotiable items, beginning with the addition of text item 502 or a number item 504 or a formula item 506, enhances the organization and structure of the system. Other items referenced in this process include the addition of a dropdown menu 508, date field 510, a text essay box 512, list value 514 and matrix field 516. The preparation of the people field 518 may be a critical step in the Crooming process, depending upon a particular implementation, which may require that this item be assigned to a team involved in negotiation process, and/or may require that an approver/signer be involved in each unique, specific negotiation. There is flexibility built into the people field to allow for many types of negotiators and also allows flexible define of the type of separators to be presented in the final negotiable document. To use a comparison, think of the document as the folder and the negotiable items as the files in the folder. In general, the CROOMER® is designed to enhance usability for both Publishers who Croom negotiable documents and users of the Croomed negotiable document for online negotiations. In large part, this is accomplished by bringing structure to the overall negotiation and giving form to the negotiable terms reflected in steps 502-524 in FIG. 5. By categorizing the items, as is seen in step/process 602 of FIG. 6.

In continuing with the example, the Publisher will begin by adding, naming, formatting, and tagging items. Steps/processes 502-506 reflect actions with respect to specific fields that may be filled out, negotiated upon, and approved by both parties in the actual negotiation. Looking at an example of a Residential Lease in CONTRACTROOM®'s Negotiation Engine, a Category name may be “Property Info” (see FIGS. 6 and 7) and the Publisher can add negotiable items through steps/processes 602, 606 such as “Rent”, which could further include items such as “Rent Price” and “Frequency”. Next, the Publisher will format the item's properties in a series of steps (504-524). In the example, “Rent Price” could be any number be a number item displayed in a number of formats, such as currency or percentage; where as “Frequency” could be represented as yearly, quarterly, monthly, etc. Negotiable Items can take on several different properties, which is why the CROOMER® tool contains a suite of options to accommodate a wide array of item properties, as illustrated by exemplary steps 502-524. To name a few, items can be text (502) fields, number (504) fields, formula (506) fields, dropdown menu (508), date (510) field, essay (512) box, list (514) value, matrix (516) field, people (518) field, text item (520) field, dropdown item (522), or even automatic tags (524). Furthermore, items can be grouped together to accommodate items that are fundamentally inseparable. In a category such as “Pets”, if the Items are Type of Pet (T) with the dropdown choices of Dog and Cat, and Weight (W) with a number field in lbs., then those Items should be coupled in the case that the tenant has several pets. In other words: T₁W₁ is dog #1 that weighs 20 lbs; T₂W₂ is dog #2 that weighs 15 lbs; and, T₃W₃ is a cat that weighs 7 lbs. All of these different properties and groupings allow Publishers to construct the perfect negotiation environment for any document, negotiable document or agreement. This itemization process helps users peel away at the original document/contract, effectively separating its text from its negotiable terms, while simultaneously assigning digital attributes to these negotiable items. The CROOMER® tool only creates the structure of the dynamic environment where the negotiation occurs.

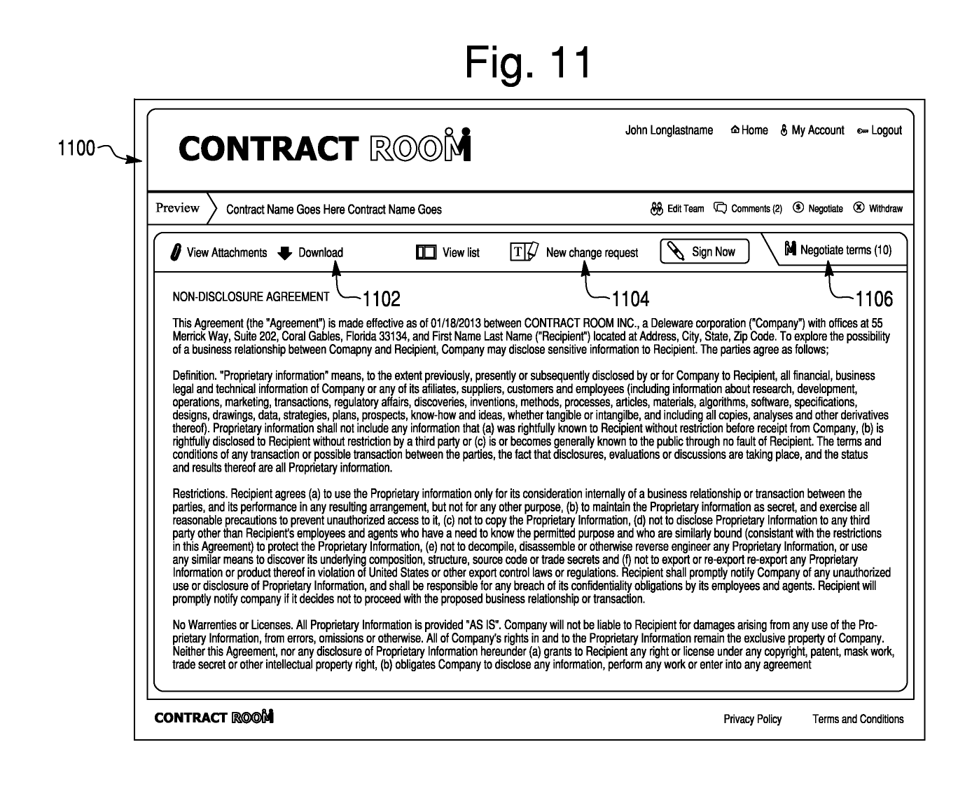

At any point, the Publisher can make modifications by making selections as seen in the illustration 600 in FIG. 6, such as adding a new category 602, reviewing the contract info 604, setting categories and items 606 and adding to text 608. With tags assigned to every negotiable item, the item and all of its properties can be easily tagged back to the negotiable document text so that the system can automatically reconstruct the negotiable document once the negotiation is complete (see FIG. 11). Once this is completed, whatever is inputted for that item during the negotiation process/instance, it will automatically be placed where it was tagged in this step so as to accurately execute negotiable document reconstruction and finalization process.

Finally, the Publisher may need to set the publishing settings as shown in step/process 610 in FIG. 6. The “Croomed Contract” can be made public or private depending on the contract. However, in this example, the Croomed negotiable document is specific to the realty company and will be made private. Next, the Publisher can set permissions, as in step/process 302 in FIG. 3 so that other employees at CONTRACTROOM® can work on this Croomed negotiable document if need be, as for example through steps 404-414 in FIG. 4, among other possibilities. And, lastly, the Croomed negotiable document will be sent to the Owner for Approval. In this example, this will be the Sales Manager. The Manager will receive an email requesting his approval. He will be directed into a View-Only state in the CROOMER® to review the Croomed negotiable document for Approval or Rejection. To move forward in the process, the Manager sees no problems in the Croomed negotiable document and approves it or rather publishes it in step 414. The Croomed negotiable document will become Active in the Publishers “Croomed Contract” library (see FIG. 7) where negotiators can start a new online negotiable instance (step/process 702). The negotiator also has the option to enter into an offline negotiation instance (step/process 704). It will be archived there and can be accessed by the Publisher in the future to make edits, view, etc.

The “Croomed Contract” will be made available in the Contract Owner's (i.e. Manager's) account. The original negotiable document is now a dynamic, negotiable negotiation environment that is compatible with all of CONTRACTROOM®'s functionality. With reference to FIG. 8A, when the Manager logs into his CONTRACTROOM® account, he will initially be directed to his dashboard to perform an initial step 801. With the original negotiable document ready to be used for negotiations, the next step is for the manager to authorize his/her Sales Associates to use the negotiable document in their own accounts.

To do this, he/she will set the appropriate permissions by proceeding to a “Permissions” page where such permissions can be verified in step 804. The manager selects the appropriate Croomed document in step 806 and a specific, unique name for the negotiation environment, and then is prompted to create the negotiation team by adding users to the environment in step 810. There are different roles that users will be assigned during a negotiation, which is handled by the Enter Collaborators' Data step 812 and then defining and assigning the appropriate roles and permissions for each individual or team member in step 814.

Although the functionality of the roles described in the narrative will remain the same, the naming conventions for the roles may change. For the time being, think of “Team Leaders” as the lead player in a negotiation. By making each of the Sales Associates a Team Leader for the negotiable document, the Sales Associates will be able to create, structure, and manage their own negotiations, and the business and legal process flows using that negotiable document environment. Immediately after the Manager adds all of the Sales Associates to the contract, an email will be sent to each of the Sales Associates alerting them that a negotiable document is available in their Contract Library (FIG. 7). Now, all of the Sales Associates can use that document template/canvas to create, perform, and finalize a negotiation in a CONTRACTROOM® environment.

In the example, the Sales Associate will use this data-based, negotiable document template/canvas to create a negotiation in a “Contract Room” environment. A “Contract Room” environment is the name given to the environment that hosts a single negotiation session or instance. This is different than CONTRACTROOM®, which denotes the entire platform. Therefore, Sales Associates may have several Contract Room environments in CONTRACTROOM® relating to several different negotiations.

When a Sales Associate signs into his account, he will first be directed to his dashboard (FIG. 7). The dashboard gives the option to “Start a Contract Room” (step/process 702) environment, as well as display the user's history of “Contract Room” environments. As defined above, “Contract Room” environment, here, means an instance or session of negotiation. To continue with the example, the Sales Associate wants to begin a negotiation with a potential tenant and the tenant's team. He/she will do this by creating a new Contract Room environment offer specific to this negotiation, beginning in step 801. This is because Contract Room environments are configured to match the pre-defined (via the CROOMER® tool) negotiable business and legal process. For example, another type of transaction process that can be negotiated in a Contract Room environment is a Request for Proposal (“RFP”) bidding process. This is possible because of CONTRACTROOM®'s flexible interface, which can incorporate several bidders or parties into a single negotiable transaction.

Returning to FIG. 8A, to begin this new Contract Room environment, the Sales Associate clicks on the Residential Lease template and selects “Start New Contract” step 801. After naming the contract, the Sales Associate will be prompted to build his negotiation team by adding players to the team and assigning each player their appropriate permissions in step 810. The user who initiates the Contract Room environment is the Team Leader, which gives him complete control over his team's negotiation. In order to give the other players permissions, the Team Leader will use a dropdown box next to the player's name and check the permissions for that player in step 814. These permissions include: the ability to negotiate, to approve, to view-only, to add more users, to appear in the contract, and to sign the contract. Next, the Team Leader will create the Counterparty's team by typing in the Counterparty's data in step 816. Once the Sales Associate is finished setting up the negotiation and entering his offer data in step 818 and then sending 822 internally for the appropriate review in step 828 and gaining the appropriate approvals internally. The internal reviewer will provide their approval and/or feedback (steps 832a, 832b, 868) and then re-send internally for further modification of negotiable item offers (steps 870, 872, 874a, 874b) or, if approved, a notification will be sent in step 834 to the Counterparty's Team Leader, who will receive an invitation into the negotiation environment and be provided the ability to build his/her own team in step 836.

Following the creation of a Contract Room environment, the subsequent workflow of the actual negotiation works in a way that allows the players in each team to work as a team, communicating with one another internally in order to come to a consensus (steps 828-866) as shown in FIGS. 8A and 8B. Furthermore, the negotiation engine is designed to expedite the negotiation process, giving every player the tools to perform their role effectively, conveniently, and quickly (steps 878-894).

The next step is to perform the negotiation. Access to the Contract Room environment is sent to the Team Leader's (Sales Associate's) team for an internal negotiation and collective approval of the terms. The players in the team will receive an email and be directed to the negotiation. The negotiation is structured according to the “Categories” and negotiable “Items” that were defined in the Crooming process and the Create a Contract Room environment process, thereby providing a digital structure to what in the industry are commonly unstructured negotiations. On an active negotiation page, the Categories work as tabs on the left side of the negotiation environment and indicate to the user the status of that category in the negotiation (FIG. 9). The users can navigate through the tabs and preview (step 912) the negotiable document to perform their roles, as well as make comments (step 906) that only their teammates can see (see FIG. 8B, steps 824, 846, 856, 864, 868). The players assigned to be negotiators will comb through the Negotiable document Room environment selecting whether the negotiable item is “OK” or “Not OK” (steps 832, 844, 854, 862, 874). If the negotiator selects “Not OK”, he will be prompted to edit the negotiable item and make a comment to his teammates. Automatic alerts are sent to the players of the team when something has changed in the negotiation or the negotiation requires their attention. Only after all of the negotiable items are approved internally can the negotiable document be sent to the counterparty. To continue with the example, it is assumed that all of the players on the Sales Associate's team have selected “OK” for the negotiable items. The Team Leader will then be alerted that the negotiation has been agreed upon internally, and can now be sent to the Team Leader of the counterparty for negotiation.

The counterparty will be taken through a very similar business and legal process. The Team Leader of the counterparty will first build his team and assign player permissions in steps 836-838. The counterparty will now perform internal negotiations agreeing or disagreeing with the terms put forth by the Sales Associate's team. If a negotiator on the counterparty disagrees with a negotiable item and makes changes to the contract, then the applicable players on the counterparty must agree to the changes (steps 854, 862). Once again, only after all of the negotiable items are agreed upon internally will the negotiable document be sent to the other party. This back-and-forth cross-party negotiation workflow will continue until both parties agree on all of the negotiable items, or the negotiation is withdrawn by the Team Leader (step/process 908). At any time during the negotiation, the Team Leader can review the negotiation history (step/process 910) add or remove players (step/process 904) to the negotiation, as well as preview (step 912) and withdraw (step 908) the negotiable transaction. If both of the parties agree on all of the terms, then the Team Leader can initiate the final execution process by sending (step/process 902) the negotiable document into the signature process (FIG. 8B, steps 876-894).

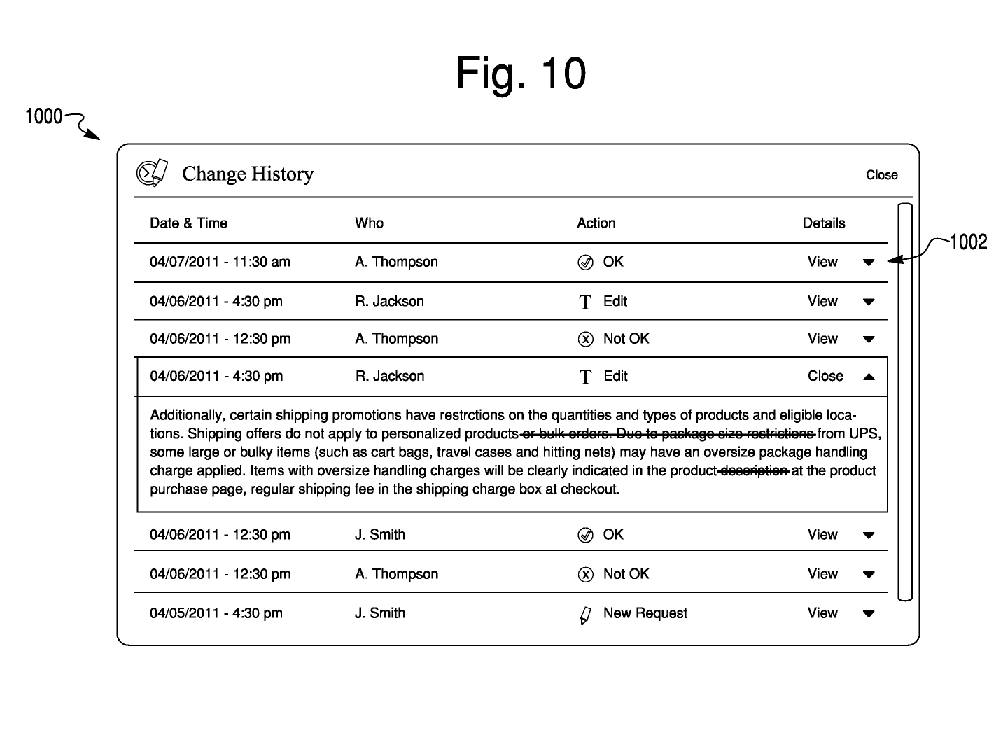

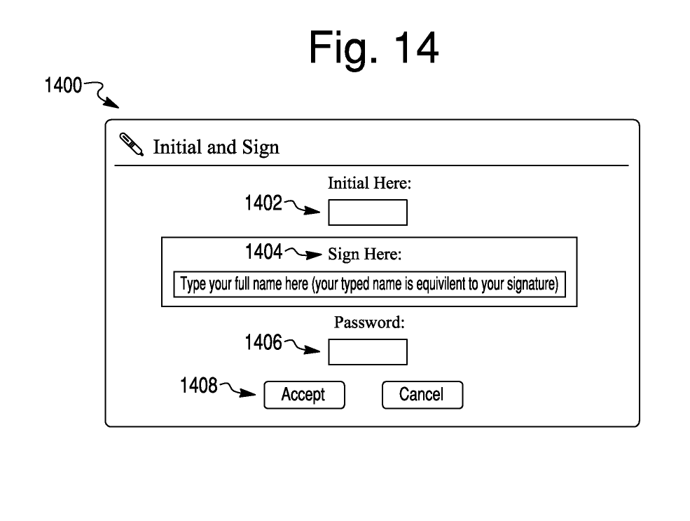

To finalize the agreement, the negotiable document is legally executed through the use of Electronic Signature capabilities. E-Signature tools in accordance with the invention are designed to make negotiations easy, while upholding the fidelity of the negotiating and contracting process. As noted above, when all of the points in the negotiable document are completed, the negotiable document will become available for Signatures and Initials (FIG. 14). Only the players who have permission to sign the negotiable document will be provided a link to initial and sign the negotiable document in steps 876 and 880, as illustrated in FIG. 8B. The link will prompt the user to input their initials (step 1402) and signature (step 1404), then accept the terms of the negotiable document (FIG. 14). The system will verify the signer by requiring a password (step 1406) entry prior to advancing to the next step. To bind the agreement between the parties, the user will be required to click “Accept” (1408). The Finalized preview will show who has signed the negotiable document and who still needs to sign. Only after all of the necessary signatures are completed will the negotiable document be executed. At such time, the final document/contract will automatically be stored on the user's dashboard, and can also be printed for a paper record or stored in electronic format in the system and all negotiation history (FIG. 10) will be stored in the system. All negotiation history for a specific negotiation instance can be accessed at any time (step 1002).

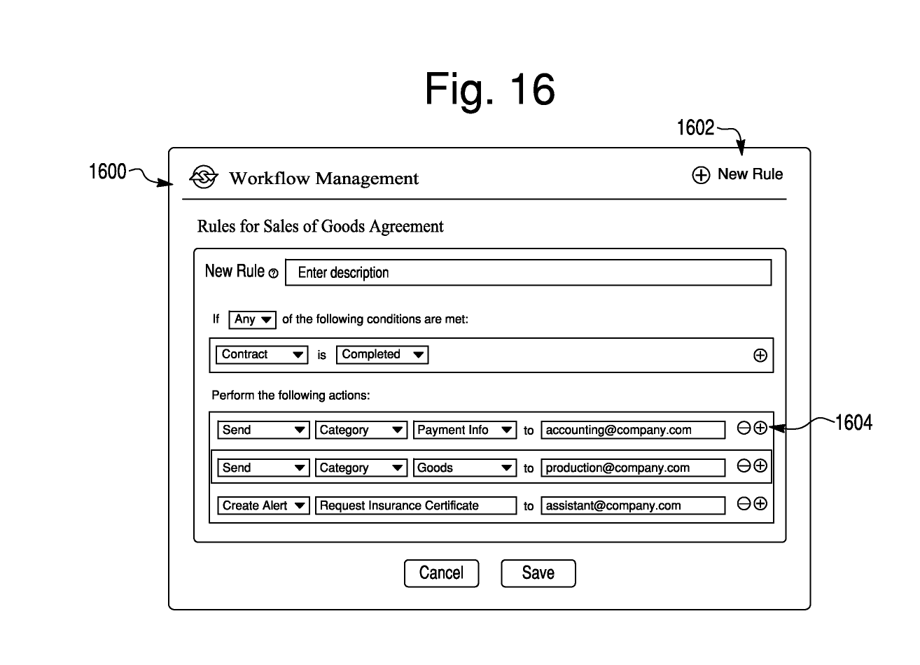

CONTRACTROOM® has a robust metrics component (FIG. 15). Since the negotiation and document/contract data are live in the system, the user has access to both pre- and post-negotiation intelligence and metrics.
1. Real-Time Sales Pipeline: the system provides information on documents in negotiation, their potential total sales and their likely projected total sales (a percentage of potential total).
2. Deal Making analytics: the system breaks down the deal by term. Over time, the system alerts (step 1504) the user of terms that are dealmakers and those that are deal breakers. As the system gains more intelligence, it will advise the user of how to best negotiate an agreement based on probability analytics.
3. Productivity: the system oversees the production by user and by team. Managers get a snapshot into each salesperson's deal-making strengths and weaknesses. Also, the user can query on profitability by deal based on discounts, etc.
4. Deal Risk: the system analyzes points where a deal is at risk. Some of the variables assessed are: time of deal, price tolerance, and more. As more deals are done through CONTRACTROOM®, the system will notify the user if a deal is at risk based on previous performance analytics.
5. Manager Control: the system provides for custom, real-time sign offs on deals in progress and allows for customizable reports (step 1502). So, if a salesperson is agreeing to drop a price below a pre-set threshold, the system notifies the manager, in real time, requiring management sign off. This avoids messy negotiable document clean up after a deal has been done.
   The system also provides a dynamic “Workflow Management” component, as illustrated in the screen shot in FIG. 16 and therein controls the dissemination of the agreed-upon, negotiable data and text to the appropriate stakeholders in such negotiation for purposes of post-contract execution. The negotiators have the flexibility to add rules (step/process 1602) for each workflow action as well as add/delete workflow rules (step 1604)

Since the system gathers data from transaction activity and publication of the final understanding and/or agreement, it is able to process and analyze such data real-time and subsequently stream processed information, or rather, business intelligence to negotiation participants or other stakeholders. The system can also extend negotiation workflow post-execution to interface and deliver real-time data to other technology solutions within an enterprise so as to report on user activity or provide financial, management, and performance metrics, or other user-defined analytics.

CONTRACTROOM® verifies users and authenticates contracts using technology that enables users to: trust the legal admissibility of the contract, protect against negotiable document fraud and forgery, look-up and cross-reference a printed, emailed or downloaded negotiable document against the authenticated negotiable document that is stored in CONTRACTROOM®'s secure cloud databases at any time, track who has looked-up and viewed the contract, authenticate contracts for third-party affiliates, demonstrate to customers that the negotiable document owner or general business is concerned with security and credibility, as well as rely on CONTRACTROOM®'s trusted services and network to securely store and endorse their sensitive business contracts in steps 890-892 in FIG. 8B.

CONTRACTROOM®'s mission is to be the global standard in virtual negotiations and to transform the business and legal process involved in negotiable transactions. To attain the highest levels of negotiable document authentication, CONTRACTROOM® uses a method of first verifying and securing the user through a login process, then authenticating user's electronic signature, and authenticating the contracts with a Trust Seal. The user's login and electronic signature can be authenticated in incremental levels by adding unique identifiers that increase the accuracy of the user's identity and actions.

CONTRACTROOM®'s system automatically archives all negotiations and contracts with a history and audit log. This allows users to keep track of all negotiating and contracting activities. Accordingly, all of a user's executed contracts are stored in a digital format on CONTRACTROOM®'s secure databases with an accompanying history to the user's account (FIG. 10). Executed contracts cannot be manipulated once executed or authenticated on CONTRACTROOM®. To add an extra safeguard, CONTRACTROOM® automatically generates a CRC32 code unique to every document to ensure that the negotiable document has not been modified. However, executed contracts can be printed out or downloaded from CONTRACTROOM®. Once printed or downloaded, the negotiable document may be susceptible to forgery or require further verification. In order to maintain the authenticity and fidelity of the contract, a CONTRACTROOM® Seal system of verification and authentication may be utilized. Every executed negotiable document in CONTRACTROOM® is automatically issued a unique identification code and accompanying barcode. It is important to note, however, that CONTRACTROOM®'s seal can be issued to any contract, as long as it is uploaded into and authenticated by CONTRACTROOM®'s Trust Seal requirements. These requirements include verifying the identities of all parties in the negotiable document (using the technology described herein) and authenticating the content of the negotiable document (using authentication protocols, which include: all relevant parties consent to the terms of the negotiable document through a non-downloadable negotiable document certification software and legally admissible E-Signature technology).

Every CONTRACTROOM® Authentication Seal has a unique barcode embedded in it. The barcode may be in the form of a QR Code (Quick Response Code), standard UPC (Universal Product Code), both types of barcode or potentially other barcode or other identification technology for increased compatibility. The barcode correlates to a single negotiable document that has been authenticated against CONTRACTROOM®'s Trust Seal requirements and is currently being stored in CONTRACTROOM®'s databases. When the negotiable document is printed or downloaded from CONTRACTROOM®'s website, CONTRACTROOM®'s authentication seal is automatically added to every page in the negotiable document like a watermark. Using this barcode and a downloadable barcode scanner application, or potentially any smartphone camera, the actual negotiable document can be pulled from CONTRACTROOM®'s secure databases for viewing on a wireless or mobile device. This way the printed or downloaded negotiable document can be compared for exact authenticity against CONTRACTROOM®'s secure records.

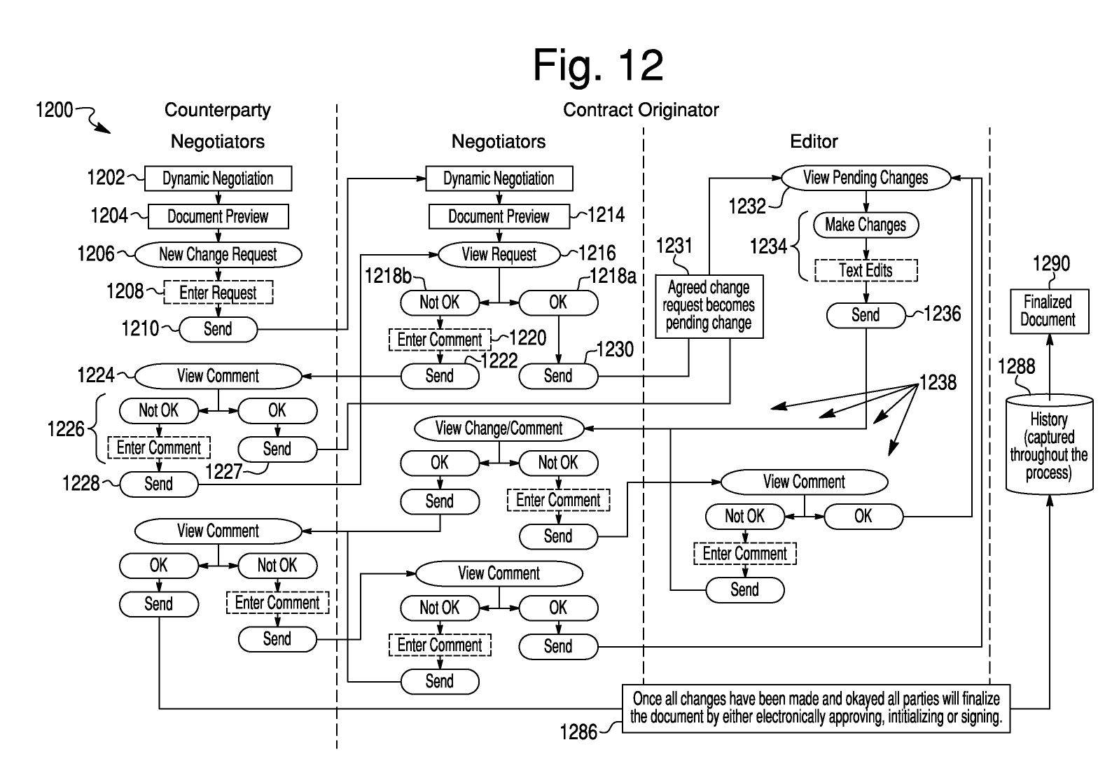

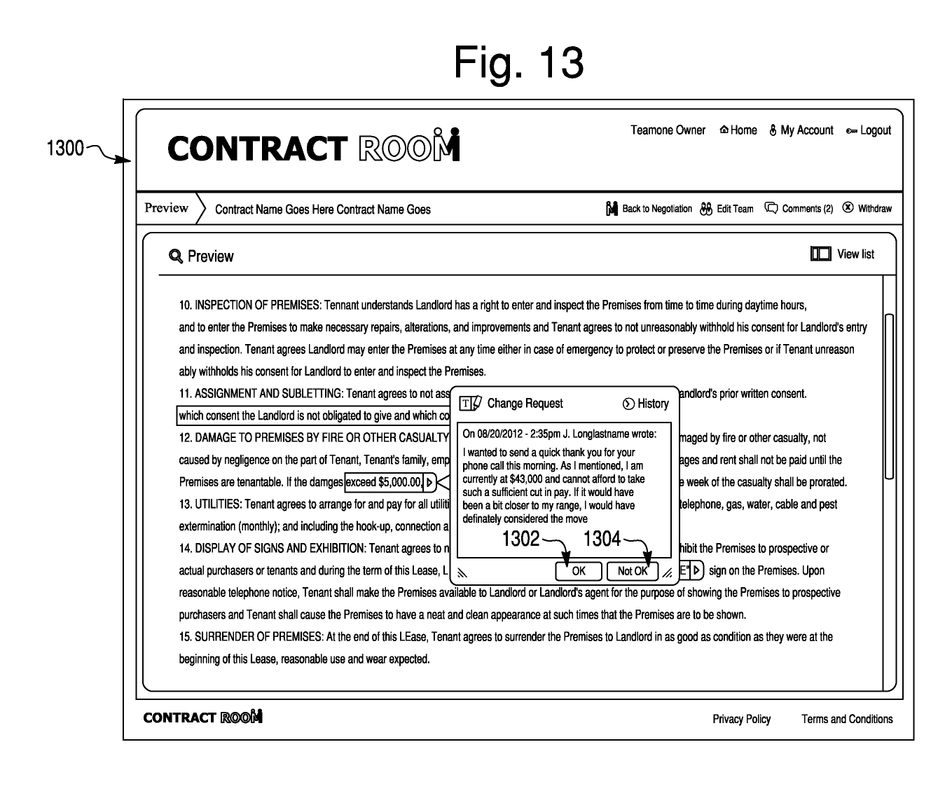

As discussed herein, a system and method of the invention further seeks to provide, in a comprehensive platform for transaction management, a system and method for collaborative drafting of a negotiated document. In one embodiment, as shown as a flow diagram in FIG. 12, and in the accompanying screenshot of FIG. 13, a method 1200 comprising many or all of steps 1202-1290 in accordance with the invention proceeds as described herein. The authoring method 1202-1290 is provided by way of illustration only, as countless variations are contemplated. References in the text are to steps or logical decision points in accordance with FIGS. 1, 8A, 12,

In this illustrative embodiment, the method 1202 begins with the counterparty. Following initial negotiations, and a review of a document created by the “Contract Originator (FIG. 12), the counterparty can request changes of the text. To start, the counterparty user clicks on the Preview button (FIG. 12, step 1204) for a system containing the negotiable document to be authored. The Preview shows the most recent iteration of the negotiated document, similar to the illustration in FIG. 11. The Preview is generated real-time. The system merges Category negotiable terms (business data) with the document's text. To request a text change, the user clicks on the New Change Request button in step 1206 (FIG. 12) and as seen on FIG. 11 (1104), featuring a capital letter T with a Pencil. The negotiator can at any time return to review the negotiable business terms by selecting the tab, “negotiate terms”, as seen on FIG. 11 (1106). He/she also has the option to download (1102) a version of the document preview in various formats, such as PDF.

The Counterparty (not “contract originator”) now has the ability to highlight (in yellow) an area in the document's preview. Once the area has been highlighted, a modal box appears, which may be activated in step 1208 of FIG. 12. The modal box has two input fields, as illustrated in FIG. 13: the first is a subject line, which the system automatically prepopulates. The second box must be input by the user with details of the change being requested. As with the other approval steps within the negotiation instance, the user is presented with a OK (1302) or Not OK (1304) option. These steps are collectively illustrated in as “Enter Request” step 1208. Once the request is completed, the user sends the request to the negotiators on the Contract Originator side in step 1210.

FIG. 12 next moves to the originating party. The “Contract Originator” clicks on the Preview button in step 1214. User then sees all Change Requests generated by the Counterparty. Each change request previews as, in one embodiment, a red highlight bar over the text for negotiators (and yellow highlight bar for view-only users) that is affected by the change request and a corresponding modal box that shows the subject line and change request from the counterparty. As above, the Contract Originator can click on View Request 1216 or, at any time, click View List (FIG. 11) to see a summary list of all Change Requests.

The Contract Originator who is designated as negotiator must address each Change Request. User has two options: to Okay (step 1218a) or Not Okay (step 1218b) the Request (FIG. 12). If the originator Okays (step 1218a) the change request, the text highlighted in red or yellow turns to green, and is sent in step 1230 to an approved Author/Editor for redraft, as described herein.

If the originator designates the change request as Not Okay (1218b), a modal box will appear allowing the Negotiator to enter a Counter-Comment, and the text highlighted in red turns to yellow. If the Contract Originator has a team with another negotiator, each negotiator must go through the same change request approval process. Comments may be viewed or added (steps 1220, 1238) along the way. Once all negotiators have agreed upon each change request, they will be sent in step 1222 to the counterparty for viewing in step 1224 of the originator's comments, Okays and Not Okays.

An iterative process 1226 may then ensue, during which the comments and “Not Okays” are approved or not approved and further negotiated, as necessary. Specifically, as above, the counterparty that is designated as negotiator must address each Counter-Comment. User has two options: to Okay or Not Okay the Request. If the counterparty Okays the change request, the text highlighted in red or yellow turns to green. If the counterparty does Not Okay the change request, a modal box, similar to illustration in FIG. 13, will appear allowing the Negotiator to enter a Counter-Comment and the text highlighted in red turns to yellow. If the counterparty has a team with another negotiator, each negotiator must go through the same change request approval process.

Once all counterparty negotiators have agreed on each change request, the Contract Originator may see the counterparty's comments, “Okays” and “Not Okays”, after they are transmitted to their side in step 1228 of FIG. 12. The change request negotiation continues until all parties have Okayed (resolved) all change requests, at which time, all agreed commentary is sent to the Editor/Author for the Contract Originator in step 1227. Each change request is designated as a Pending Change in step 1231, and made available to the Editor/Author for redrafting purposes.

Only the Contract Originator and/or a team member who is the designated Author/Editor is granted rights for a redraft. Now that the status of all change requests have been changed to Pending Changes, the authorized Author/Editor can now see a list of pending changes in step 1232). The Author/Editor reviews each Pending Change and inputs/incorporates the requested text change into body text of the agreement in step 1234.

The Editor/Author's changes are then sent in step 1236 to, and then approved by, authorized team members if Editor/Author is working with a team, or becomes available for the counterparty to Okay or Not Okay. This iterative process as described herein and further illustrated in step 1238 proceeds until a consensus is reached. The text that has been changed now appears with yellow or red highlights, depending on who is viewing. Red indicates that the user has a pending action. Yellow indicates the user does not have a current action, and that the next action is pending on another user in that negotiation.

As reference, any or all approved users may be provided access to a History (method 1000) and all associated changes (FIG. 10). The history also shows rewrites of the copy and tracks the text modifications within the Change Request modal box. Once all users have Okayed, a Pending Change that has been modified by the Editor/Author, the copy is highlighted in green for all parties, meaning the text is approved. Depending upon the system configuration, when the Preview button is selected, the viewer may see only the most recently approved negotiated text and data, or more of the history. Changes can be requested and made up until all parties have finalized the document. Users will finalize the document by either electronically approving, initializing or signing in step 1286 of FIG. 12. Changes may be tracked in step 1288 throughout the process, providing the ability to display a detailed history if desired. The system will incorporate all changes and provide access to designated parties to the finalized document in step 1290.

### Software as a Service (SaaS) Technology

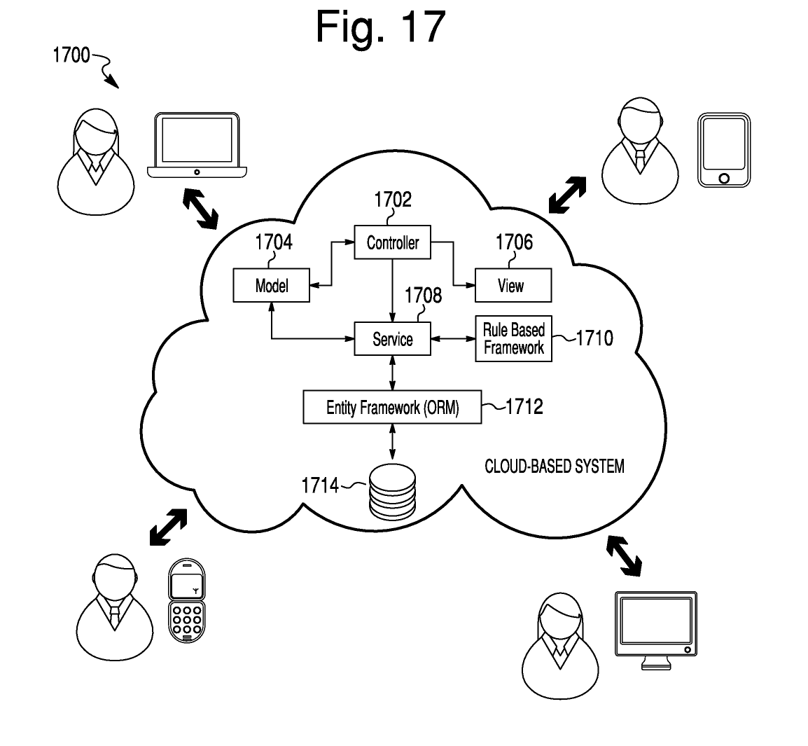

The dynamic transaction management system and method herein disclosed might be implemented in any of a variety of ways, depending upon a particular application, among other variables. In one embodiment, the features of the invention are incorporated into software, in the form of modules or otherwise, as would be readily appreciated by one skilled in the art. SaaS denotes a computing environment where multiple customers access the software application over the Internet (FIG. 17). It is delivered using a shared infrastructure, a single-code base, where all customers share a common application instance and database from an architectural perspective. A key element is also on-demand self-service or automated self-provisioning. SaaS employs a consumption-based model for billing, via a monthly subscription or a fee-per-transaction model. The invention might also be practiced outside a SaaS context, as where software is delivered on a computer readable medium, firmware, cloud-based, etc., or any suitable combination of the above or others, depending upon a particular application, keeping in mind that certain features are more readily implemented via certain platforms. In the illustration put forth FIG. 17, there are a number of system components described as follows:
1. The “controller” layer (1702) that can send commands to its associated view so as to change the view's presentation of the model. It can also send commands to the model.
2. The “model” layer (1704) that notifies its associated views and controllers when there has been a change in its state. This notification allows the views to produce updated output, and the controllers to change the available set of commands.
3. The “view” layer (1706) requests from the model the information that it needs to generate an output representation to the user.
4. The “services” layer (1708) accesses the database through the object relational mapping, and the controller interacts with this layer to change the model's state.
5. The “rule-based framework” (1710) functionality provides application behavior rules as needed during workflow.
6. The “entity framework” (1712), object relational mapping, provides direct access to database (1714) to feed the service layer.

Countless other features as well might, within the scope of the invention, differ from the embodiments described herein. For example, while described in context of a full-featured contract management system, real estate contract, or other specific type of document, etc., the invention might be applied to any other field, and any other transaction as well in which the disclosed features might find utility, e.g., where terms are negotiated or otherwise evolve over time, where a history of the same is important, where issues of document security are involved, etc. A system and method of the invention might also be offered as, for example, a stand-alone method or service or for incorporation into any suitable system. Furthermore, the invention is not limited to authoring of a negotiated contract, but rather might find applicability in countless environments in which multiple parties are collaborating in any of a variety of ways on a document. While the term “document” is used herein to denote an item of interest to be authored, the invention is not limited to physical manifestations, but rather could take any form, electronic or otherwise.

As a means of illustration, screenshots of webpages and logic flows of embodiments of the invention are provided. The description may reference an individual step in a flow diagram, but need not be limited to a single step; rather, the referenced step may be a series of steps or otherwise comprise a more detailed process or procedure. Depending upon a particular application, however, variations are contemplated in aesthetic presentation, organization, and even logic flows and decision trees, without departing from the scope of the invention.

What is claimed is:

1. A method for offering any number of negotiators a single, comprehensive platform for electronically negotiating an original document over a securitized public network, the method comprising:
enabling a first negotiator to upload the original document as a negotiable document to be negotiated into storage accessible over the public network;
deconstructing the negotiable document into 1) an original document template 2) building blocks, including deconstructing text of the document;
following deconstruction of the document, creating a dynamic, negotiable transaction environment and instance;
establishing negotiable and non-negotiable terms of the document in data fields;
restructuring the building blocks of the negotiable document in a specialized digital format for online negotiation of terms of the negotiable document between two or more negotiators through one or more iterative steps;
providing an online negotiation interface for enabling the online negotiation of the terms of the negotiable document between the two or more negotiators through one or more iterative steps;
following a completion of the negotiation, linking the document in the online negotiation interface back to the template of the original document for finalization.

2. The method of claim 1, wherein the template of the original document comprises non-negotiable boilerplate text.

3. The method of claim 2, wherein the single, comprehensive platform is based in software, the platform controlling all negotiable transactions and activities, including one or more of the following: deal administration, collaborative authoring, proactive communication, dynamic collaboration, workflows and metrics.

4. The method of claim 3, wherein the non-negotiable terms of the document are established in fixed data fields, and negotiable tennis of the document are established in variable data fields.

5. The method of claim 4, further comprising:
enabling users to create unique negotiation environments for every platform-generated negotiation offer.

6. The method of claim 5, further comprising:
enabling users to define who participates in the negotiation.

7. The method of claim 6, further comprising:
providing secure access to system;
guiding users through a process of creating a negotiation environment;
capturing and controlling all movement, activities, comments, inputs, changes (i.e., history) as data to shared, tracked and processed for document execution and negotiation intelligence.

8. The method of claim 7, wherein negotiation teams can be created, administered and directed, the method further comprising:
enabling a leader user to add and delete team members throughout the negotiation process; and
enabling the leader user to define negotiation participation rights and roles for any member of the user's team.

9. The method of claim 8, further comprising:
defining a negotiation creator and a negotiation leader;
enabling the negotiation creator to identify when approval and consensus on offer content has been achieved; and
enabling the negotiation leader to notify a counterparty negotiation leader to review contents of the offer content.

10. The method of claim 9, wherein the negotiation creator defines how users negotiate and what they negotiate, the method further comprising:
granting users access to only certain content in the negotiation by assigning variable rights to negotiate items chosen from: sections, clauses, categories, items and text.

11. The method of claim 10, further comprising:
enabling the negotiation creator to define workflows for negotiation teams to ensure accurate and efficient outcomes of a negotiation process and delivery of executed negotiation data to pre-defined stakeholders in execution on the negotiation data either via email, application programming interfaces (APIs) or system integration.

12. The method of claim 11, wherein the platform allows negotiation creators to populate all metatag fields that relate to a transaction that forms a part of the negotiation.

13. The method of claim 12, wherein the platform streams notifications to team members indicating that they must approve or reject each of the metatag fields, the method further comprising:
monitoring and tracking team negotiation ensuring that the team members approve each negotiable metatag field.

14. A method for transforming a document into a dynamic, negotiable transaction environment for subscriber access through a defined workflow of deconstructing paper- and text-based documents, including:
deconstructing the document into terms, including at least one pre-defined negotiable term;
creating unique metatags for the pre-defined negotiable term;
establishing within the deconstructed document locations indicating where negotiable term data is to be merged within formatted text content of the document;
assigning permission levels to subscribers; and
publishing approved negotiation environments for which subscribers are to be permitted access based on the assigned permission levels.

15. The method of claim 14, further comprising:
assigning to negotiators permission levels of offer originator; and
granting to negotiators access to a library of dynamic, negotiable transaction environments.

16. A system for collaborative, data-driven negotiation and document authoring over a network, comprising:
a dynamic negotiation management component configured to replicate business and legal negotiation processes for one or more types of document, including but not limited to contracts and agreements;
a negotiation engine in communication with the dynamic negotiation management component over the network;
a server computer in communication with at least one recipient computer system over a network, the server computer configured to enforce a permissions-based access policy that controls access by the at least one recipient computer system to the negotiation engine controlling a dynamic collaborative negotiation environments for building consensus and agreement on data terms and enabling a document authoring process on text terms to effectively control context and content sharing through a negotiation process.

17. The system of claim 16, further comprising:
a digitized template environment in communication with the server computer and modifiable by users through the generation of new instances of dynamic collaborative negotiation, wherein the new instances of dynamic collaborative negotiation are based on existing templates created through the dynamic negotiation management component.

18. The system of claim 17, further comprising:
a storage component in communication with the dynamic negotiation management component for storing data, activities, comments and history generated during negotiation and document authoring; and
a user interface in communication with the server computer for providing to the users all components of the system as well as user-generated data entered in the dynamic collaborative negotiation and document authoring environments.

19. The system of claim 18, further comprising:
server components programmed to display information in a Web browser and mobile application;
server components programmed to allow authorized users to assign roles and permissions for dynamic negotiation collaborators and transmitting automated e-mail messages containing details of the dynamic negotiation instance, instructions and URL;
server components programmed to allow all collaborators to review negotiable terms and approve, reject or add comments;
server components programmed to allow all authorized users to download an electronic document featuring all terms dynamically negotiated and authored in the system;
server components programmed to allow users designed as signers to execute agreements through mechanisms including but not limited to electronic signature, electronic initials and electronic sign-off;
server components programmed to allow authorized users to access the history and metrics modules with detailed activity log and statistics originated in one or many dynamic collaborative negotiations conducted in the system; and
server components programmed to allow authorized users to configure automated tasks triggered by predefined events during the dynamic collaborative negotiation and document authoring process.

20. The system of claim 16, wherein the transmitted URL is included in a Web site accessed by the Web browser.

21. The system of claim 20, the server computer and negotiation engine being further configured to transmit the received approvals, rejections, comments, and electronic signature data to one or more authorized users.

22. The system of claim 21, wherein the collaborative negotiation templates/canvases/environments specify data restrictions, and wherein the server computer is further configured to enforce such data restrictions.

23. The system of claim 22, wherein the server computer and negotiation engine is further configured, based on a permission-based access policy, to suppress access to users not authorized to access specific complete or partial dynamic collaborative negotiation instances.

24. The system of claim 23, wherein the user interface is further configured to:
collect data values from authorized users of the dynamic collaborative negotiation instance; and
include the collected data values in the history and metrics logs and statistics.

25. A method for publishing an approved negotiation offer for review by a negotiation counterparty, wherein a process of collaboration, modification and acceptance by a negotiation originator and the negotiation counterparty is performed in a digital, parallel, systematized environment, the method comprising:
providing a platform for negotiation between a first party and a second party;
inviting a negotiation counterparty leader into a negotiation environment;
linking a receiving party of an offer into a specific workflow to define participation rights and roles of users for the negotiation;
monitoring when teams and individuals reach consensus before inviting a second party to review a new iteration of the negotiation;
providing a status of the category negotiation indicating what action is required at that time, wherein red indicates a pending action for the negotiation participant, yellow indicates a pending action for a second participant, green indicates a term is approved by the first party to the negotiation, and green with a check mark indicates the term is approved by the first and second parties to the negotiation;
allowing for a negotiation withdrawal process, wherein the negotiation withdrawal process comprises a formal legal process of withdrawing from the negotiation, which in turn forces immediate termination of the negotiation session and offer;
controlling a dynamic process of renegotiation, wherein the process of renegotiation allows the negotiation process to be reset to a last instance of agreement and allows for the negotiation workflow to continue from the last instance of agreement; and
overseeing each user's response time and creating systematic, automatic alerts, wherein the negotiation environment creator may define the amount of time each user has to respond to any change in the text or metatag content.

26. The method of claim 25, further comprising:
distinguishing between public and private commenting;
determining who can be included in commentary and can establish privacy against others; and
controlling communication flow between public and private commentary.

27. A method for collecting negotiation and document content data from specific unique negotiable transactions, comprising:
seamlessly streaming the data to specific recipients wherein based on user preference;
analyzing the data to provide negotiation and business metrics for enhanced business performance;
enabling system integration with other technologies to feed negotiation data to applications;
enabling system configuration for sending information to individuals via email;
providing individual user dashboard that reports on active and completed negotiations;
providing enterprise dashboard for designated users that provides such intelligence as agreement performance analysis, aggregate sales, employee performance, risk of losing a negotiation, percentage of completion of sale pipeline;
providing industry or vertical intelligence based aggregate data collected and processed via computer-drive algorithms, analytics and metrics; and
creating inferences, workflows, analytics, metrics and/or intelligence for system users from the data collection methodology and processes.

28. A method for monitoring activity of a negotiation of a negotiable document, comprising:
a negotiation engine controlling how the negotiation is managed;
the negotiation engine automatically identifying a moment in time that all negotiation team members are in agreement on a first term;
based upon the negotiation engine automatically identifying the moment in time that all negotiation team members are in agreement on the first term, triggering sequential logic to take the negotiation to the next step;
recognizing when all negotiators have reached agreement all terms; and
tracking and informing when a user has not responded to an invitation to participate.

29. The method of claim 28, further comprising:
based upon recognizing when all negotiators have reached agreement on all terms, thereby notifying designated signers of the negotiable document they may now sign.

30. The method of claim 1, further comprising:
during negotiation and pre-execution and pre-signature, permitting users to view on demand the most recently approved version of the negotiated document;
following execution, permitting the users to append addendums upon approval by all negotiation parties, thereby modifying the most recently approved version of the negotiated document;

32. The method of claim 30, further comprising:
include a watermark on a printed document to be compared with system signature information so as to authenticate and prevent fraud, wherein a document can be authenticated through a barcoding system.

33. The method of claim 32, further comprising:
executing a final version of a negotiable session;
storing all transaction history of all activities and commentary by negotiators involved in that specific transaction on the platform.

34. The method of claim 1, further comprising:
controlling a process of drafting and re-drafting by having counterparty negotiators provide comments on document text;
permitting counterparty negotiators to provide commentary only on proposed changes to text by the individual counterparty;
providing commentary to an originating party and allowing for acceptance or rejection of such commentary;
if commentary is accepted, permitting an editor for the originating party to make actual changes to text;
presenting changed text to the counterparty for final approval;
if the changed text is agreed to, modifying the negotiable document accordingly; and
when all terms have been fully agreed to, moving the workflow towards negotiation execution.
